(19) United States
(12) Patent Application Publication
(10) Pub. No.: US 2008/0204891 A1
(43) Pub. Date: Aug. 28, 2008

(54) Method and Device For Controlling a Variable Focal Length Liquid Lens

(75) Inventors: Nicolas Tallaron, Chambery (FR); Pierre Craen, Lyon (FR); Bruno Berge, Lyon (FR)

Correspondence Address: FOLEY AND LARDNER LLP;SUITE 500, 3000 K STREET NW, WASHINGTON, DC, 20007, US

(73) Assignee: VARIOPTIC

(21) Appl. No.: 11/910,007

(22) PCT Filed: Mar. 30, 2006
(86) PCT No.: PCT/EP2006/061205

§ 371 Date: Sep. 28, 2007

(30) Foreign Application Priority Data
Mar. 30, 2005 (FR) 0550812

(51) Int. Cl. G02B 3/12

(52) U.S. Cl. 359/666

(57) ABSTRACT

The present invention concerns a method for controlling a variable focal length lens (10) comprising a dioptre (28) capable of being deformed by variation of the electro-wetting characteristics by application of a control voltage (V), wherein a focal length value corresponds to a given control voltage in the steady state, said method comprising: —applying, during a transition between the application of a first control voltage (V₁) corresponding to a first focal length value (f₁) and a second control voltage (V₂) corresponding to a second focal length value (f₂), a control voltage which is different from the first and second control voltages and changes according to a given profile that depends on the first and second control voltages.

### FIELD OF THE INVENTION

The present invention relates to a method and a device for controlling a variable focal length lens comprising a mobile dioptre capable of being displaced via electro-wetting by application of a control voltage to terminals of the lens. The present invention relates more particularly to a method and a device for supplying the control voltage applied to the terminals of such a variable focal length lens.

### EXPLANATION OF THE PRIOR ART

U.S. Pat. No. 6,369,954 describes several exemplary embodiments of a variable focal length lens comprising a mobile dioptre whose position can be controlled via electro-wetting.

FIG. 1 very schematically represents an exemplary embodiment of such a variable focal length lens. The lens 10 comprises a compartment 12 consisting of a side wall 14, an upper wall 16 and a lower wall 18, the upper and lower walls 16, 18 being at least partially transparent. The compartment 12 contains a centring piece 20 comprising a conical recess 22 of axis D. The compartment 12 is filled with two immiscible liquids 24, 26 having similar densities and different refractive indices. By way of example, the liquid 26 arranged in the recess 22 is an aqueous liquid and the liquid 24 is an oily liquid. The separation surface of the two liquids constitutes a dioptre 28. An electrode 30 is arranged in contact with the liquid 24. A conically shaped electrode 32 is arranged at the centring piece 20, substantially next to the conical recess 22. A voltage generator 34 is adapted to apply a variable voltage V between the electrodes 30 and 32. A control module 36 receives a control signal S_{C}, for example representative of a focal length to be obtained, and controls the generator 34 so as to apply a voltage between the electrodes 30, 32 in order to obtain the desired focal length.

In the absence of a voltage between the electrodes 30, 32, the dioptre 28 occupies an equilibrium position represented by a solid line A. As the voltage between the electrodes 30, 32 increases, the perimeter of the dioptre 28 moves in the recess 22, which modifies the curvature of the dioptre 28 and therefore the focal length of the lens 10. The broken line B represents an exemplary position of the dioptre 28 during the application of a non-zero voltage. The voltage applied between the electrodes 30 and 32 may be a DC voltage or an AC voltage. In the latter case, the rms voltage of the applied AC voltage will be considered. The relation between the applied voltage and the focal length obtained in the steady state may be stored in the control module 36.

In general, the change from an initial focal length value f₁ corresponding to a voltage V₁ to a final focal length value f₂ corresponding to a voltage V₂ is carried out by successively supplying the voltages V₁ and V₂ using the generator 34.

FIG. 2 illustrates the change in the focal length f of the lens 10 when the voltage V applied between the electrodes 30, 32 varies from V₁ to V₂. The transition between the voltages V₁, V₂ is carried out quasi-instantaneously and at a time t₀. The variation in the focal length is not instantaneous, since an increase of the focal length f from the initial value f₁ to the final value f₂ occurs at the end of a duration Δt referred to as the response time of the lens.

Such voltage control presents several drawbacks. For instance, the duration Δt may be excessively long whereas it is often desirable for a focal length change operation to be as fast as possible. Furthermore, in particular when the difference between the voltages V₁ and V₂ is large, the dioptre 28 may not maintain a spherical shape during the response time of the lens 10. The optical quality of the lens 10 is then degraded during the response time. The lens 10 is therefore not operational during a focal length change operation.

It is an object of the present invention to provide a method and a device for controlling a variable focal length lens comprising a mobile dioptre capable of being displaced via electro-wetting, which makes it possible to reduce the response time of the lens during a focal length change operation and/or to maintain a sufficient optical quality of the lens during a focal length change operation.

It is another object of the present invention to provide a control method which is simple to implement and a control device which has a simple design.

### SUMMARY OF THE INVENTION

In order to achieve these objects, the present invention provides a method for controlling a variable focal length lens comprising a dioptre capable of being deformed by variation of the electro-wetting characteristics by application of a control voltage, wherein a focal length value corresponds to a given control voltage in the steady state. During a transition between the application of a first control voltage corresponding to a first focal length value and a second control voltage corresponding to a second focal length value, the method comprises applying a control voltage which is different from the first and second control voltages and changes according to a given profile which depends on the first and second control voltages, in order to shorten the variation time of the focal length from the first focal length value to the second focal length value and/or to maintain a desired optical quality of the lens during the said transition.

According to one embodiment, the method comprises the steps of selecting a profile from among a set of pre-stored profiles as a function of the first and second control voltages; and applying the selected profile.

According to one embodiment the method comprises, at least during a part of the transition, applying a voltage step higher than the second control voltage if the first control voltage is lower than the second control voltage; or a voltage step lower than the second control voltage if the first control voltage is higher than the second control voltage.

According to one embodiment the method comprises, at least during a part of the transition, successively applying a first voltage step higher than the second control voltage and a second voltage step lower than the second control voltage if the first control voltage is lower than the second control voltage; or a first voltage step lower than the second control voltage and a second voltage step higher than the second control voltage if the first control voltage is higher than the second control voltage.

According to one embodiment, the method furthermore comprises the steps of measuring, during the said transition, a signal representative of the sharpness of an image formed in an image formation region; in determining the value of the said representative signal for which focusing is obtained; on the basis of the profile and the said value of the representative signal, in determining the value of the focal length for which focusing is obtained; and in determining the control voltage to be applied in the steady state in order to obtain the said value of the focal length.

The present invention also provides a device for supplying a control voltage to a variable focal length lens comprising a dioptre capable of being deformed by electro-wetting by application of the said control voltage, wherein a focal length value corresponds to a given control voltage in the steady state. The device comprises a means for supplying, during a transition between the application of a first control voltage corresponding to a first focal length value and a second control voltage corresponding to a second focal length value, a control voltage which is different from the first and second control voltages and changes according to a given profile which depends on the first and second control voltages, in order to shorten the variation time of the focal length from the first focal length value to the second focal length value and/or to maintain a desired optical quality of the lens during the said transition.

According to one embodiment, the device comprises a means for storing a set of profiles, the device being further adapted to select a profile from among the set of stored profiles and to supply a control voltage changing according to the selected profile.

The present invention also provides an automatic focusing system, comprising a variable focal length lens comprising a dioptre capable of being deformed by electro-wetting by application of a control voltage, wherein a focal length value corresponds to a given control voltage in the steady state; a device as described above for supplying the said control voltage; and a sensor adapted to measure a signal representative of the sharpness of an image formed in an image formation region during the said transition, the said control device being further adapted to determine the value of the said representative signal for which focusing is obtained; and to determine, on the basis of the profile and the said value of the representative signal, a steady state control voltage to be applied in the steady state in order to obtain a focal length for which focusing is obtained.

According to one embodiment, the control device is adapted to supply, during said transition, a series of non steady state control voltages monotonically transitioning between said first control voltage and said second control voltage. *In one embodiment, the series of monotonically transitioning non steady state control voltages forms a ramp.

According to a further embodiment, the control device is further adapted to supply a stabilization voltage to said variable focal length lens for a determined duration and then to supply said steady state control voltage. The stabilization voltage is preferably lower than said steady state control voltage when said first control voltage is lower then said second control voltage, and higher than said steady state control voltage when said first control voltage is higher than said second control voltage.

According to yet a further embodiment, the control device is adapted to determine a non steady state control voltage on the basis of the profile and the said value of the representative signal, and to correct said non steady state control voltage by a voltage difference ΔV to determine said steady state control voltage to be applied in the steady state.

The present invention also provides an optical device or a barcode reader comprising a variable focal length lens comprising a dioptre capable of being deformed by electro-wetting by application of a control voltage, wherein a focal length value corresponds to a given control voltage in the steady state; and a control device according to any of the above mentioned embodiments, for supplying said control voltage to the variable focal length lens.

Embodiments of an optical device according to the present invention comprise, for example, a lens module having a number of fixed lenses and one or more variable focal length lenses, a sensor for receiving an image via the fixed and variable lenses, and a control device which controls the variable focal length lens. In particular, the control device preferable comprises a processing means, which is for example an image signal processor, which is able to process algorithms for determining the control voltages to be applied to control the variable lens. The processing means also preferably receives signals from the sensor representative of the sharpness of an image formed in an image formation region of the sensor, and determines the required focal length and/or required control voltage based on these signals from the sensor. The processing means preferably further comprises driving circuitry for generating the control voltages for driving the variable lens.

The optical device is for example a digital camera, a mobile telephone comprising a camera module, a barcode reader or an alternative optical device.

### BRIEF DESCRIPTION OF THE DRAWINGS

These objects, characteristics and advantages, as well as others of the present invention, will be explained in detail in the following description of particular exemplary embodiments, which is given without implying limitation, and with reference to the appended figures, in which:

FIG. 1, already described, schematically represents a variable focal length lens and an associated control device;

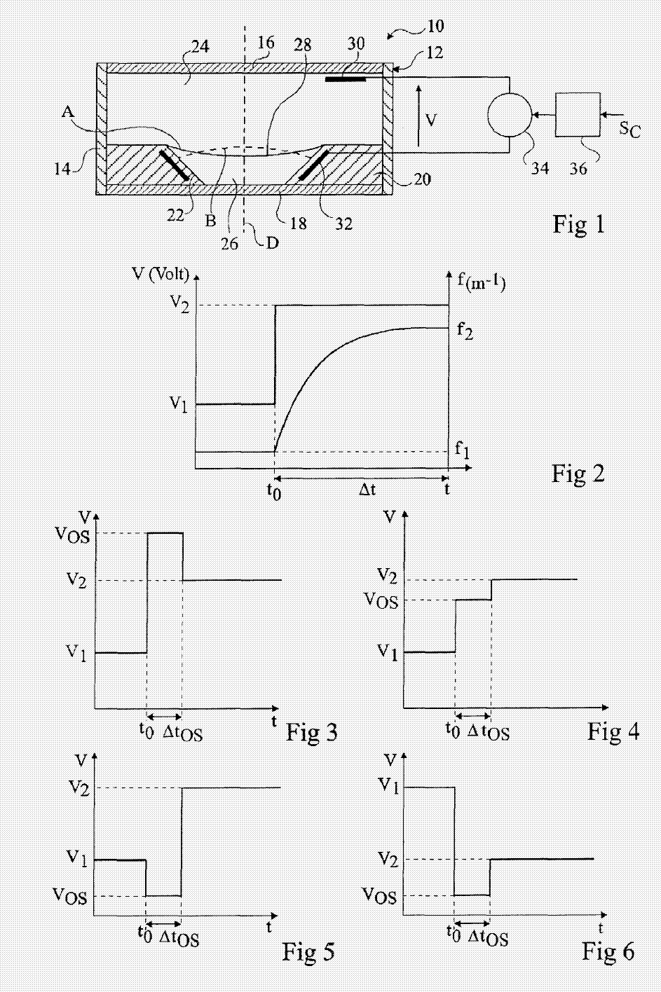

FIG. 2, already described, represents the change in the focal length of the lens of FIG. 1 during the successive application of two control voltages;

FIGS. 3 to 29 each illustrate an example of the inventive control of a variable focal length lens;

FIG. 30 represents an exemplary application of the method according to the invention for controlling a variable focal length lens in order to automatically perform focusing; and

FIGS. 31A to 31C describe the method for performing automatic focusing according to an embodiment of the application represented in FIG. 30.

### DETAILED DESCRIPTION

In the following description, the term voltage is used equally to denote the value of a DC voltage applied between the electrodes 30, 32 of the variable focal length lens 10 or the value of the rms voltage of an AC voltage applied between the electrodes 30, 32 of the variable focal length lens 10, depending on the type of variable focal length lens 10 being used.

The present invention proposes that a constant or variable voltage, the change of which is perfectly controlled and corresponds to a predetermined voltage profile, should be applied between the electrodes 30, 32 of the variable focal length lens 10 during the transition from the control voltage V₁ to the control voltage V₂. Depending on the profile used, it is then possible to reduce the response time, that is to say the duration of the variation in the focal length of the lens from the initial value f₁ associated with the control voltage V₁ to the final value f₂ associated with the control voltage V₂ and/or to ensure that a sufficient optical quality of the lens 10 is maintained during the focal length change.

The present invention can be implemented for example in an optical device comprising a variable focal length lens and a control device for supplying said control voltage (V) to the variable focal length lens. The control device comprises for example processing means for determining the required control voltage value and driving circuitry for generating the control voltage.

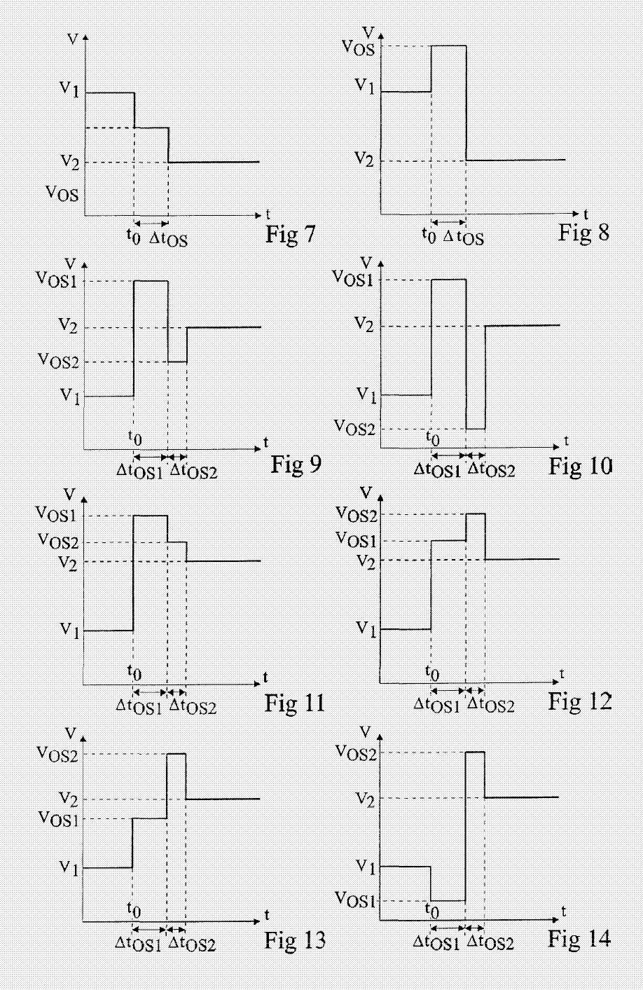

In the rest of the description, the term transition corresponds to the change in the control voltage between the voltages V₁ and V₂ according to the voltage profile, and the expression “increase (decrease) in the variation rate of the focal length” means that the variation rate of the focal length is higher (lower) than the variation rate of the focal length obtained when changing quasi-instantaneously from the voltage V₁ to the voltage V₂, as represented in FIG. 2.

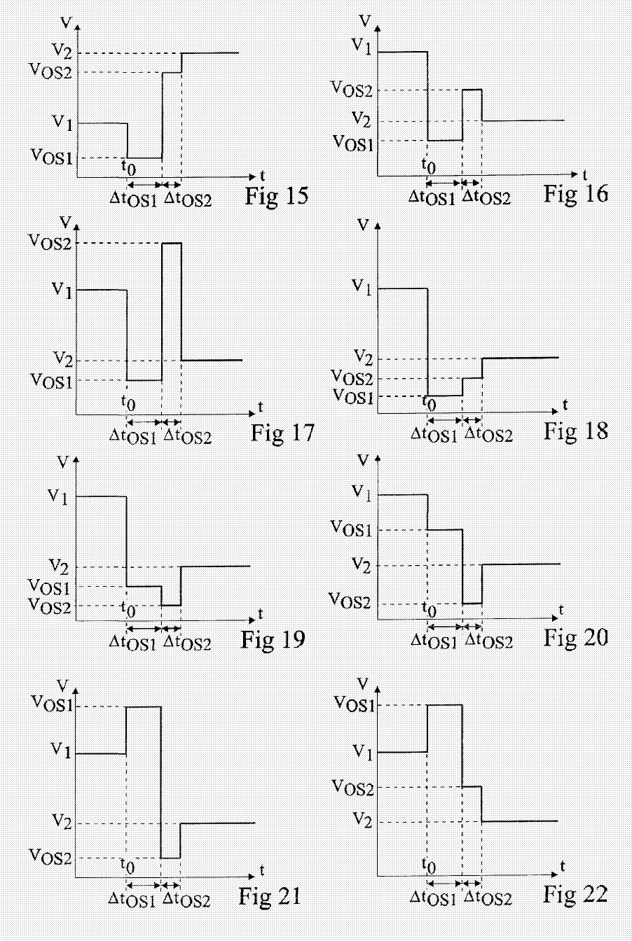

FIGS. 3 to 5 illustrate examples of a control method according to the invention, in the case when the voltage V₁ is lower than the voltage V₂. For such examples, the control method according to the invention consists, at a time to, in applying a voltage step V_{OS} is a duration Δt_{OS} before the application of the voltage V₂. The voltage Vₒₛ and the duration Δt_{OS} are determined according to the following rules:

the voltage V_{OS} must be less than the maximum control voltage that can be supplied by the generator 34 and accepted by the lens 10;
the greater |V_{OS}−V₁| is, the faster the variation in the focal length is and the more the response time of the lens 10 can be reduced;
the greater |V_{OS}−V₁| is, the greater the degradation of the optical quality of the lens 10;
the longer the duration Δt_{OS} is, the more the response time of the lens 10 can be reduced; and
the longer the duration Δt_{OS} is, the greater the risk is that the focal length of the lens will temporarily exceed the value f₂ if V_{OS} is higher than V₂.

In the rest of the description, a voltage step does not necessarily correspond to a perfectly constant voltage, but more generally corresponds to a voltage which changes little with respect to the reaction timescale of the lens.

In FIG. 3, V_{OS}>V₂. The variation rate of the focal length is then increased in order to reduce the response time of the lens.

In FIG. 4, V₁<V_{OS}<V₂. Such a control example may be employed when it is desired to maintain a sufficient optical quality of the lens 10 during the focal length change from f₁ to f₂. This is because a degradation of the optical properties of the lens 10 tends to occur particularly at the start of the variation in the focal length when |V₂−V₁| is large. By providing an intermediate voltage step V_{OS}, the initial voltage difference seen by the lens 10 is decreased, thus reducing the degradation of the optical properties of the lens 10.

In FIG. 5, V_{OS}<V₁<V₂. Substantially the same effects are encountered as in the exemplary embodiment illustrated in FIG. 3. In fact, even if the focal length change is firstly to an intermediate value further from f₂ than f₁ is, the lens 10 will then see a voltage difference |V₂−V_{OS}| which is greater than |V₂−V₁|, which significantly increases the variation rate of the focal length and overall makes it possible to reduce the response time of the lens 10.

FIGS. 6 to 8 illustrate control method examples in the case when the voltage V₁ is higher than the voltage V₂, which are equivalent to those illustrated respectively in FIGS. 3 to 5.

FIGS. 9 to 15 illustrate control method examples in the case when the voltage V₁ is lower than the voltage V₂. For such examples, the control method consists in successively applying two voltage steps V_{OS1} and V_{OS2} at the time t₀, respectively for durations Δt_{OS1} and Δt_{OS2}.

The determination of V_{OS1} and Δt_{OS1} follows the following rules:

V_{OS1} must not exceed the maximum control voltage that can be supplied by the generator 34 or accepted by the lens 10;
the greater |V₁−V_{OS1}| is, the more the response time of the lens 10 can be reduced;
the greater |V₁−V_{OS1}| is, the greater the degradation of the optical quality of the lens 10 may be;
the longer the duration Δt_{OS1} is, the more the response time of the lens 10 can be reduced; and
the longer the duration Δt_{OS1} is, the greater is the risk that the focal length of the lens will temporarily exceed the value f₂ if V_{OS1} is higher than V₂.

The determination of V_{OS2} and t_{OS2} follows the following rules:

V_{OS2} must not exceed the maximum control voltage that can be supplied by the generator 34 or accepted by the lens 10;
the greater |V_{OS1}−V_{OS2}| is, the more the response time of the lens 10 can be reduced;
the greater |V_{OS1}−V_{OS2}| is, the greater the degradation of the optical quality of the lens 10 may be;
the longer the duration Δt_{OS2} is, the longer the duration Δt_{OS1} may be and therefore the more the response time can be reduced; and
the longer the duration Δt_{OS2} is, the greater is the risk that the focal length will depart from f₂.

In FIG. 9, V₁<V_{OS2}<V₂<V_{OS1}. In this case, the variation rate of the focal length is increased at the start of transition and decreased at the end of transition.

In FIG. 10, V_{OS2}<V₁<V₂<V_{OS1}. The same effects are encountered as in the control example described with reference to FIG. 9, with a more pronounced decrease of the variation rate of the focal length at the end of transition.

In FIG. 11, V₁<V₂<V_{OS2}<V_{OS1}. In this case, the variation rate of the focal length is increased greatly at the start of transition and the increase in the variation rate of the focal length is decreased at the end of transition by application of a voltage V_{OS2} lower than V_{OS1}.

In FIG. 12, V₁<V₂<V_{OS1}<V_{OS2}. In this case, the variation rate of the focal length is increased moderately at the start of transition then such a rate increase is sustained at the end of transition by application of a voltage V_{OS2} higher than V_{OS1}. This exemplary embodiment is adapted in the case when it is not desired to apply too high a voltage difference at the start of transition, in order to avoid an excessive degradation of the optical quality of the lens while nevertheless obtaining an increase in the variation rate of the focal lens.

In FIG. 13, V₁<V_{OS1}<V₂<V_{OS2}. The variation rate of the focal length is decreased at the start of transition and increased only at the end of transition. An improvement of the optical quality of the lens is then favoured.

In FIG. 14, V_{OS1}<V₁<V₂<V_{OS2}. In this case, the lens focal length is initially varied in a direction opposite to the desired direction, so as to obtain a large voltage difference |V_{OS2}−V_{OS1}| which greatly increases the variation rate of the focal lens and reduces the response time of the lens 10.

In FIG. 15, V_{OS1}<V₁<V_{OS2}<V₂. In this case, the difference |V_{OS2}−V_{OS1}| still being large, a large increase in the variation rate of the focal length is obtained. However, the risk that the focal length will exceed the final value f₂ is limited since V_{OS2}<V₂.

FIGS. 16 to 22 illustrate control method examples in the case when the voltage V₁ is higher than the voltage V₂, which are equivalent to the control method examples illustrated respectively in FIGS. 9 to 15.

FIGS. 23 to 26 illustrate other control method examples in the case when the voltage V₁ is higher than the voltage V₂, which consist in the successive application of two voltage steps V_{OS1} and V_{OS2}. Such control method examples can be transposed to the case when the voltage V₁ is lower than the voltage V₂.

In FIG. 23, V₂<V₁<V_{OS2}<V_{OS1}. In this case, an increase in the variation rate of the focal length is favoured.

In FIG. 24, V₂<V_{OS2}<V_{OS1}<V₁. In this case, the voltage V₁ changes to the voltage V₂ via two intermediate voltage steps. This exemplary embodiment applies more particularly to the case when it is desired to maintain a sufficient optical quality throughout the focal length change.

In FIG. 25, V₂<V_{OS1}<V_{OS2}<V₁. In this case, the variation rate of the focal length is decreased at the start of the transition in order to maintain a sufficient optical quality, then the variation rate of the focal length is increased at the end of transition.

In FIG. 26, V₂<V_{OS1}<V₁<V_{OS2}. In this case, the variation rate of the focal length is decreased at the start of the transition in order to maintain a sufficient optical quality, then the variation rate of the focal length is increased significantly at the end of transition.

FIGS. 27 to 29 illustrate other exemplary embodiments of the control of a variable focal length lens in which the voltage V₁ is lower than the voltage V₂. Such examples can be transposed to the case when the voltage V₁ is higher than V₂.

FIG. 27 illustrates a control example in which the voltage applied to the lens 10 is varied continuously over a duration Δt_{OS} between the voltage V₁ and the voltage V₂ according to a predefined curve, which in the present example has a positive slope that decreases progressively to zero. In this example, the degradation of the optical quality of the lens 10 is limited.

FIG. 28 illustrates a control example in which, successively, a voltage step V_{OS1} higher than V₂ is applied over a duration Δt_{OS1} then, over a duration Δt_{OS2}, the control voltage is decreased from a voltage V_{OS2} lying between V₂ and V_{OS1} to the voltage V₂ according to a continuously decreasing curve. A significant increase in the variation rate of the focal length is thus obtained at the start of transition, while limiting the risk of exceeding the focal length f₂ at the end of transition.

FIG. 29 illustrates a control example in which, successively, a voltage step V_{OS1} higher than V₂ is applied over a duration Δt_{OS1} then, over a duration Δt_{OS2}, the control voltage is increased from a voltage V_{OS2} lying between V₁ and V₂ to the voltage V₂ according to a continuously increasing curve. A significant increase in the variation rate of the focal length is thus obtained at the start of transition, followed by a significant decrease in the variation rate of the focal length at the end of transition.

According to one exemplary embodiment of the present invention, a plurality of control profiles according to the exemplary embodiments described above are stored in the control module 36. As a function of the voltages V₁ and V₂ to be applied, the control module 36 is then adapted to select the profile from among the various stored control profiles which allows certain criteria to be best satisfied, in particular reducing the response time of the lens or maintaining the optical quality of the lens during the focal length change. In fact, the control profile making it possible to best satisfy a given criterion may differ according to the amplitude of the difference |V₂−V₁|, according to the levels of the voltages V₁ and V₂ and the type of lens.

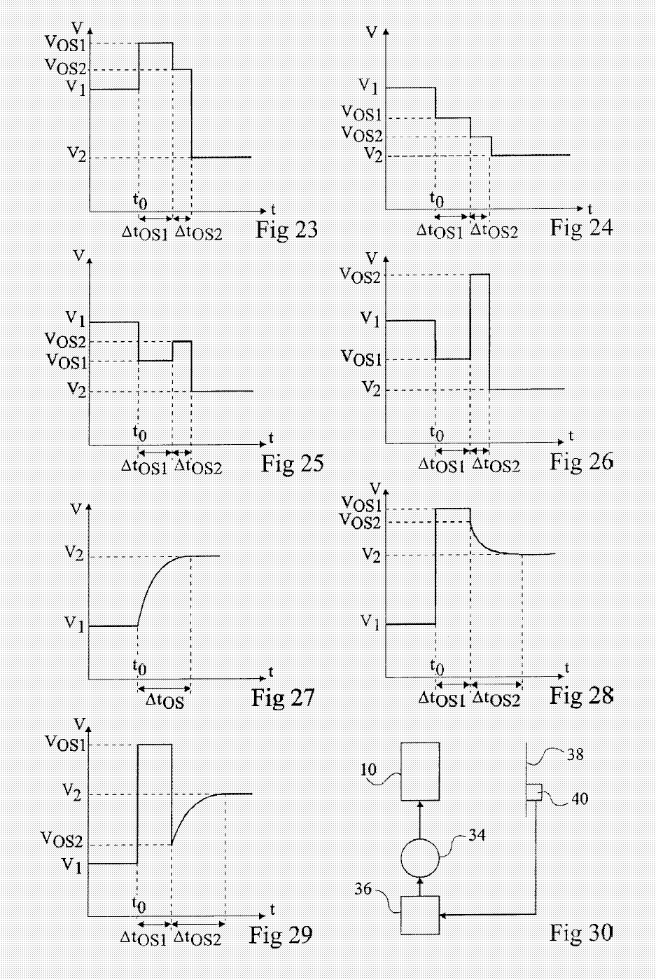

FIG. 30 represents a particular exemplary embodiment of the control method according to the invention in order for an image provided by the lens 10 to be automatically focused in an image formation region 38. A sensor 40 is arranged in the region 38 and makes it possible to analyze at least one portion of the image formed in the region 38. The sensor 40 is adapted to transmit a signal, representative of a merit function, for example the sharpness of the image formed in the region 38, to the control module 36.

The automatic focusing method consists in varying the control voltage supplied by the generator 34 between voltages V₁ and V₂ corresponding to focal distances f₁ and f₂ sufficiently far apart so that the focal length f_{focus}, for which focusing would be obtained, lies between f₁ and f₂. The control profile applied for the transition between V₁ and V₂ is such that the optical quality of the lens 10 is preserved throughout the response time of the lens 10. For example, it is then possible to provide a voltage profile according to the exemplary embodiment described with reference to FIG. 24 or 27. During the response time, the sensor 40 continuously analyzes the image which is formed in the region 38, and supplies the control module 36 with the signal representative of the sharpness of the image formed. The control module 36 stores the signals supplied by the sensor 40 and determines the time, referred to as the focusing time, for which the received sharpness signal corresponds to focusing being obtained. The control module 36 can then determine the focusing focal length f_{focus}. In order to do this, a theoretical curve of the change in the focal length of the lens 10 as a function of time, resulting from the application of the control voltage profile being used, may be stored in the control module 36. The focusing focal length f_{focus} then corresponds to the value of the focal length of the theoretical variation curve at the focusing time. The control module 36 then determines the control voltage which makes it possible to obtain the focal length f_{focus} in the steady state. The control module 36 then drives the generator 34 so that it supplies such a control voltage. Such a method makes it possible to perform focusing very rapidly.

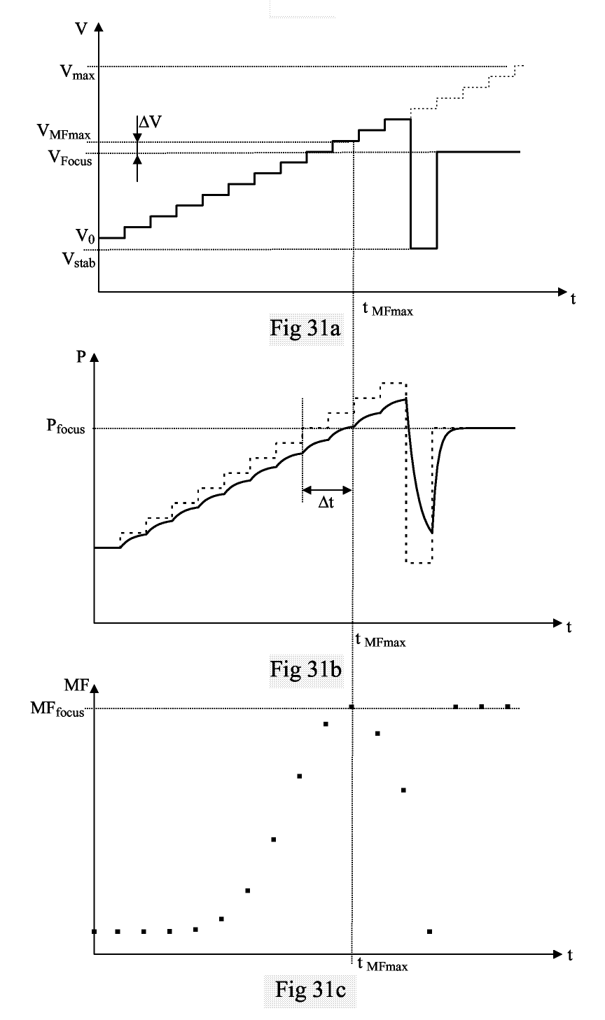

FIGS. 31A to 31C illustrate the automatic focusing method as described above, for an optical system including a variable focal length lens, according to an exemplary embodiment. The optical device typically comprises one or a plurality of fixed lenses, the variable focal length lens and a sensor, the overall optical combination, together with the sensor characteristics, defining the depth of field of the optical device.

FIG. 31A represents the control voltage applied to the variable focal length lens versus time. The dotted line is the initially forecasted control voltage profile, in this case a voltage ramp, which is an extension of the voltage profile of FIG. 24 with V₁ and V₂ corresponding to V₀ and Vₘₐₓ respectively. In alternative embodiments any of the other voltage profiles described above could be used for going from V₀ to Vₘₐₓ. Whilst the ramp is an example of a monotonically increasing curve between V₀ and Vₘₐₓ, in alternative embodiments a monotonically decreasing curve from Vₘₐₓ to V₀ could be used, for example a decreasing ramp. An increasing or decreasing ramp can comprise discrete steps as in the present example, or could be a continuous linear curve.

The forecast voltage profile will be applied as long as a merit function of the image, which is for example the sharpness of the image, is increasing. As described above, the sharpness of the image can be determined by sensor 40. The solid line is the actual voltage applied.

FIG. 31B illustrates the optical power of the lens versus time, the optical power being the inverse of the focal length. The dotted line is the theoretical response of an ideal lens having a response time equal to 0, when the voltage profile of FIG. 31A is applied. The solid line is the actual optical power of the lens. As shown by the graph, the lens works in a non steady state mode in which each step is shorter than the required time duration to reach a stabilized optical power. This means that at each step the actual optical power obtained has not yet reached its theoretical value, and thus leads to a time delay between the theoretical and real optical power, which is equal to Δt the time the merit function is at a peak (t_{MFmax}).

FIG. 31C illustrates the merit function value against time, measured at each step, and represents the sharpness of the image formed in the region 38. This function is an estimation of the focus quality. As shown, the function reaches a peak at the focusing time, labelled t_{MFmax}.

The initial forecasted voltage ramp is defined such as V₀ is the starting point, Vₘₐₓ is the maximum operating voltage, each voltage step corresponds to an optical power shift smaller than the depth of field of the optical system, and the duration of each step depends on the sensor frame rate. For example, the duration is chosen to be n times the delay between two frames, where n is equal to an integer, for example 1, 2 or 3 etc. As an example, the duration of each step is chosen to be approximately 40 ms.

At the end of each step, the picture is captured and the merit function is calculated. It is ensured that the forecasted voltage ramp is applied up to a point beyond the focusing point (maximum of merit function). A criterion is defined based on the value of the merit function that stops the application of the ramp profile. This criterion is for example two successive decreasing points, in other words when the sharpness of the image at two successive points has decreased with respect to the sharpness of the image at the previous point.

The maximum merit function value at time t_{MFmax} corresponds to a given voltage, V_{MFmax}. In the embodiment of FIG. 31a, given that discrete voltage steps have been used when applying the merit function, the voltage value V_{MFmax} is known simply by storing the times that each voltage is applied to the lens, and then referring to the applied voltage at the focusing time t_{MFmax}. If however alternative profiles to this step profile are used, theoretical curves of the change in focus length with time can be used to determine the voltage value V_{MFmax}, as described above with relation to FIG. 30.

As this best focus has been obtained in a non steady state mode, this V_{MFmax} has to be corrected by ΔV to give the same focus in a steady state mode. In other words, given time to stabilize, the voltage V_{MFmax} would result in a higher optical power than the required power, and therefore needs to be reduced to compensate for this. The resulting voltage is thus

V_{Focus}=V_{MFmax}+ΔV

where V_{Focus} is the voltage to be applied to obtain the best focus. ΔV depends on the lens as the shorter the response time, the smaller ΔV, and the ramp shape, as the faster the V₀-Vₘₐₓ range is scanned, the larger ΔV.

In the present example ΔV is negative, as the non steady state voltage V_{MFmax} must be reduced to give the steady-state voltage V_{Focus}, however different embodiments, for example where the ramp decreases from Vₘₐₓ to V₀, ΔV is positive.

Once the best focus voltage V_{Focus} has been determined, a voltage profile is applied for reaching V_{Focus}, and in this example a stabilization voltage V_{stab} is used, in line with the profile shown in FIG. 6. This avoids hysteresis effects in the variable focal length lens. Thus a low stabilization voltage V_{stab} is applied before applying V_{Focus}. In case of lenses having no or low levels of hysteresis, V_{stab} does not need to be applied, and one of the alternative profiles described above is applied to increase the response time or improve the optical quality of the lens during transition between voltages. The level of hysteresis is said low when the resulting hysteresis is small compared to depth of field.

Another exemplary application of the control method according to the invention relates to a method for reading a barcode, in which an optical system, the optical power of which varies periodically between two power levels, is used in order to form an image of the barcode in an image plane. The power levels make it possible for an object situated respectively in a first object plane and a second object plane to be focused in the image plane. Such a reading method assumes that correct reading of the barcode can be carried out irrespective of the position of the barcode between the two object planes and in their vicinity, and avoids continuously having to vary the focal length of the optical system in order to focus precisely on the barcode. The optical system may consist of a variable focal length lens whose focal length changes alternately from a first focal length value to a second focal length value, the transitions between the first value and the second value and between the second value and the first value being obtained by controlling the lens according to the control method described above. In such a case, the control of the lens may correspond to a periodic function.

The present invention comprises numerous advantages:

first, the present invention makes it possible to reduce the response time of a variable focal length lens when changing focal length and/or to maintain a suitable optical quality of the lens during a focal length change;
secondly, implementation of the present invention is particularly simple since it requires storage in the control module 36 of a voltage profile, or a plurality of voltage profiles, to be applied during a focal length change.

Different variants and modifications which occur to the person skilled in the art may of course be made to the present invention. In particular, the present invention has been described for the control of a particular exemplary embodiment of a variable focal length lens. The present invention may nevertheless be applied to any type of variable focal length lens comprising a dioptre which can be moved via electro-wetting by application of a control voltage to terminals of the lens.

1. Method for controlling a variable focal length lens comprising a dioptre capable of being deformed by variation of the electro-wetting characteristics by application of a control voltage, wherein a focal length value corresponds to a given control voltage in the steady state, said method comprising:
applying, during a transition between the application of a first control voltage corresponding to a first focal length value and a second control voltage corresponding to a second focal length value, a control voltage which is different from the first and second control voltages and changes according to a given profile that depends on the first and second control voltages.

2. Method according to claim 1, comprising the following steps:
selecting a profile from among a set of pre-stored profiles as a function of the first and second control voltages; and
applying the selected profile.

3. Method according to claim 1, comprising, at least during a part of the transition time:
applying a voltage step higher than the second control voltage if the first control voltage is lower than the second control voltage; or
a voltage step lower than the second control voltage if the first control voltage is higher than the second control voltage.

4. Method according to claim 1, comprising, at least during a part of the transition:
applying a first voltage step higher than the second control voltage and a second voltage step lower than the second control voltage if the first control voltage is lower than the second control voltage; or
a first voltage step lower than the second control voltage and a second voltage step higher than the second control voltage if the first control voltage is higher than the second control voltage.

5. Method according to claim 1, comprising:
during the said transition, measuring a signal representative of the sharpness of an image formed in an image formation region;
determining the value of the said representative signal for which focusing is obtained;
determining, on the basis of the profile and the said value of the representative signal, the value of the focal length for which focusing is obtained; and
determining the control voltage to be applied in the steady state in order to obtain the said value of the focal length.

6. A method for controlling a variable focal length lens according to claim 1, wherein the focal length of the lens is alternately changed from a first focal length value to a second focal length value for the reading of a barcode.

7. Control device for supplying a control voltage to a variable focal length lens comprising a dioptre capable of being deformed by electro-wetting by application of the said control voltage, wherein a focal length value corresponds to a given control voltage in the steady state, said control device being adapted for supplying, during a transition between the application of a first control voltage corresponding to a first focal length value and a second control voltage corresponding to a second focal length value, a control voltage to said variable focal length lens which is different from the first and second control voltages and changes according to a given profile which depends on the first and second control voltages.

8. Control device according to claim 7, further comprising a means for storing a set of profiles, the device being further adapted to select a profile from among the set of stored profiles and to supply a control voltage changing according to the selected profile.

9. An optical device comprising:
a variable focal length lens comprising a dioptre capable of being deformed by electro-wetting by application of a control voltage, wherein a focal length value corresponds to a given control voltage in the steady state; and
a control device according to claim 7 for supplying said control voltage to the variable focal length lens.

10. A barcode reader comprising:
a variable focal length lens whose focal length changes alternately from a first focal length value to a second focal length value, said variable focal length lens comprising a dioptre capable of being deformed by electro-wetting by application of a control voltage, wherein a focal length value corresponds to a given control voltage in the steady state; and
a control device according to claim 7 for supplying during a transition between the application of a first control voltage corresponding to the first focal length value and a second control voltage corresponding to the second focal length value, a control voltage to said variable focal length lens which is different from the first and second control voltages and changes according to a given profile which depends on the first and second control voltages.

11. An automatic focusing system, comprising:
a variable focal length lens comprising a dioptre capable of being deformed by electro-wetting by application of a control voltage, wherein a focal length value corresponds to a given control voltage in the steady state;
a control device according to claim 7 for supplying the said control voltage; and
a sensor adapted to measure a signal representative of the sharpness of an image formed in an image formation region during the said transition,
the said control device being further adapted to determine the value of the said representative signal for which focusing is obtained; and to determine, on the basis of the profile and the said value of the representative signal, the control voltage to be applied in the steady state in order to obtain a focal length for which focusing is obtained.

12. The automatic focusing system of claim 11 wherein said control device is adapted to supply, during said transition, a series of non steady state control voltages monotonically transitioning between said first control voltage and said second control voltage.

13. The automatic focusing system of claim 11 wherein said control device is adapted to supply, during said transition, a series of control voltages in the form of a ramp between said first control voltage and said second control voltage.

14. The automatic focusing system of claim 11 wherein said control device is further adapted to supply a stabilization voltage to said variable focal length lens for a determined duration and then to supply said steady state control voltage.

15. The automatic focusing system of claim 14 wherein said stabilization voltage is lower than said steady state control voltage when said first control voltage is lower then said second control voltage, and higher than said steady state control voltage when said first control voltage is higher than said second control voltage.

16. The automatic focusing system of claim 11 wherein said control device is adapted to determine a non steady state control voltage on the basis of the profile and the said value of the representative signal, and to correct said non steady state control voltage by a voltage difference ΔV to determine said steady state control voltage to be applied in the steady state.

17. Method according to claim 1, comprising, at least during a part of the transition:
applying a voltage step lower than both the first control voltage and the second control voltage.
